(19) United States
(12) Patent Application Publication
(10) Pub. No.: US 2026/0138421 A1
(43) Pub. Date: May 21, 2026

(54) AIR VENT FOR VEHICLE

(71) Applicants: HYUNDAI MOBIS CO., LTD., Seoul (KR); ITW EF&C Korea LLC., Incheon (KR)

(72) Inventors: Seung Cheol KIM, Yongin-si (KR); Yong Seok PARK, Seoul (KR)

(73) Assignees: HYUNDAI MOBIS CO., LTD., Seoul (KR); ITW EF&C Korea LLC., Incheon (KR)

(21) Appl. No.: 19/032,731

(22) Filed: Jan. 21, 2025

(30) Foreign Application Priority Data
Nov. 19, 2024 (KR) 10-2024-0164944

(51) Int. Cl. B60H 1/34

(52) U.S. Cl. CPC B60H 1/3428

(57) ABSTRACT

An air vent for a vehicle is provided. The air vent includes: an air duct including an internal flow path along which air flows, a first flow path branched upward and a second flow path respectively branched upward and downward from the internal flow path; a first air guide and a second air guide respectively disposed on upper and lower portions of the internal flow path, the first air guide and the second guide to slide in a front-rear direction and respectively control an air volume passing through the first and second flow paths; a rotator rotatably installed on one side surface of the air duct to move the first and second air guides in different directions; and a wing module installed on each of the first flow path and the second flow path to rotate in a left-right direction and control a discharging direction of air.

### CROSS-REFERENCE TO RELATED APPLICATION

The present application claims priority to and the benefit under 35 USC § 119 of Korean Patent Application No. 10-2024-0164944, filed on November 19, 2024, in the Korean Intellectual Property Office, the entire disclosure of which is incorporated herein by reference in its entirety for all purposes.

### BACKGROUND OF THE INVENTION

### 1. Field of the Invention

The present invention relates to an air vent for a vehicle.

### 2. Description of the Related Art

In general, vehicles are provided with an air conditioning system for controlling an internal temperature according to the season, and the cold air and hot air generated from the air conditioning system is supplied to a vehicle interior through an air outlet installed on an instrument panel. The air outlet is provided with an air vent for controlling a wind direction and air volume of the hot or cold air generated from the air conditioning system.

Conventional air vents use a wing-type air vent for vertically controlling a wind direction. However, exposed wing and wing knob can reduce the degree of freedom in design, cause air volume loss, and interfere with the vertical wind direction, thereby entirely deteriorating air conditioning performance. Therefore, there is a need to improve this.

### SUMMARY

The present invention is directed to providing an air vent for a vehicle, which enables a hidden outlet without causing wind volume loss because a wing for controlling a vertical wind direction and a wing knob provided on the wing are omitted.

Objects of the present invention are not limited to the above-described object, and other objects that are not mentioned will be able to be clearly understood by those skilled in the art from the following description.

An air vent for a vehicle according to an embodiment of the present invention may include an air duct having an internal flow path along which air moves, a first flow path branched upward from the internal flow path, and a second flow path branched downward from the internal flow path, a first air guide and a second air guide which are disposed on upper and lower portions of the internal flow path, respectively, slide in a front-rear direction, and control an air volume passing through a first flow path and a second flow path, respectively, a rotator which is installed rotatably on one side surface of the air duct and moves the first air guide and the second air guide in different directions through rotation driving, and a wing module which is installed on each of the first flow path and the second flow path, rotates in a left-right direction, and controls a discharging direction of the air.

The air duct may include a duct housing and a duct frame installed in the duct housing, the duct housing has is provided with a pair of guide holes on both side surfaces extending in the front-rear direction along the internal flow path, and the duct frame is disposed in front of the internal flow path and is configured to form the first flow path and the second flow path between the duct frame and the duct housing.

The duct frame may include an upper inclined surface extending to be inclined upward at a center facing the internal flow path, an upper plane horizontally extending from an end portion of the upper inclined surface, a lower inclined surface extending to be inclined downward at a center facing the internal flow path, and a lower plane horizontally extending from an end portion of the lower inclined surface, and a wing actuator for driving the wing module may be installed in an inner space surrounded by the upper inclined surface, the upper plane, the lower inclined surface, and the lower plane.

A coupling hole surrounded by a fixing frame including a pair of vertical columns and a horizontal column connecting the pair of vehicle columns may be provided in the upper plane and the lower plane, and the wing module may be configured to be fixedly inserted into the coupling hole.

Side covers covering the guide hole and the rotator may be coupled to both side surfaces of the duct housing, and the side cover may be configured to prevent air in the internal flow path from leaking out through the guide hole.

The first air guide and the second air guide may have a plate-shaped structure extending toward both side surfaces of the duct housing, and the first air guide and the second air guide may each have a guide protrusion, which is connected to the guide hole, provided in both end portions facing the side surfaces.

The rotator may have a pair of connecting slots extending in opposite directions centered on a central rotational shaft, and a connecting pin provided on the guide protrusion of the first air guide and the guide protrusion of the second air guide may be connected to each of the pair of connecting slots.

The wing module may include an upper spacer and a lower spacer disposed parallel to each other, a plurality of wings having a rotational shaft rotatably connected to the upper spacer and the lower spacer, and a wing link rotatably connected to each of the plurality of wings, and the wing module installed on the first flow path and the wing module installed on the second flow path may be connected through a connecting link and formed to rotate in the same direction.

The air vent may further include a guide duct coupled to a front of the air duct to guide air moving along the first flow path and the second flow path to an outlet that is open to a vehicle interior, wherein the guide duct may include a first part, a second upper part forming a first air passage connected to the first flow path between the second upper part and the first part, and a second lower part forming a second air passage connected to the second flow path, and an opening may be formed in each of surfaces of the first air passage and the second air passage of the guide duct, which are coupled to the air duct.

A protrusion protruding from the opening to the second air passage may be provided on a surface of the first part, which faces the second lower part, and the protrusion may be formed to prevent a Coanda effect from occurring on a surface of the first part.

### BRIEF DESCRIPTION OF THE DRAWINGS

FIG. 1 is a view illustrating an air vent for a vehicle according to an embodiment of the present invention.

FIG. 2 is a view illustrating a configuration of the air vent.

FIG. 3 is a view illustrating cross sections of an air duct and a duct guide in the air vent.

FIG. 4 is a view illustrating portion A in FIG. 3.

FIGS. 5 and 6 are views illustrating a duct frame and a wing module coupled to the duct frame in the air duct.

FIG. 7 is a view illustrating a rotator, a first air guide, and a second air guide in the air vent.

FIG. 8 is a view illustrating a wing module in the air vent.

FIG. 9 is a view illustrating the operation of the air vent in a normal mode.

FIG. 10 is a view illustrating the operation of the air vent in an upward mode.

FIG. 11 is a view illustrating the operation of the air vent in a downward mode.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being "on", "connected to," "coupled to," or "joined to" another component, element, or layer it may be directly (e.g., in contact with the other component, element, or layer) "on", "connected to," "coupled to," or "joined to" the other component, element, or layer or there may reasonably be one or more other components, elements, layers intervening therebetween. When a component, element, or layer is described as being "directly on", "directly connected to," "directly coupled to," or "directly joined" to another component, element, or layer there can be no other components, elements, or layers intervening therebetween. Likewise, expressions, for example, "between" and "immediately between" and "adjacent to" and "immediately adjacent to" may also be construed as described in the foregoing.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being "connected to," or "coupled to" another component, it may be directly "connected to," or "coupled to" the other component, or there may be one or more other components intervening therebetween. In contrast, when an element is described as being "directly connected to," or "directly coupled to" another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

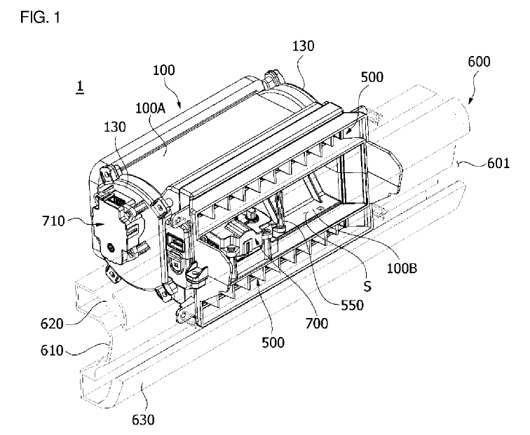

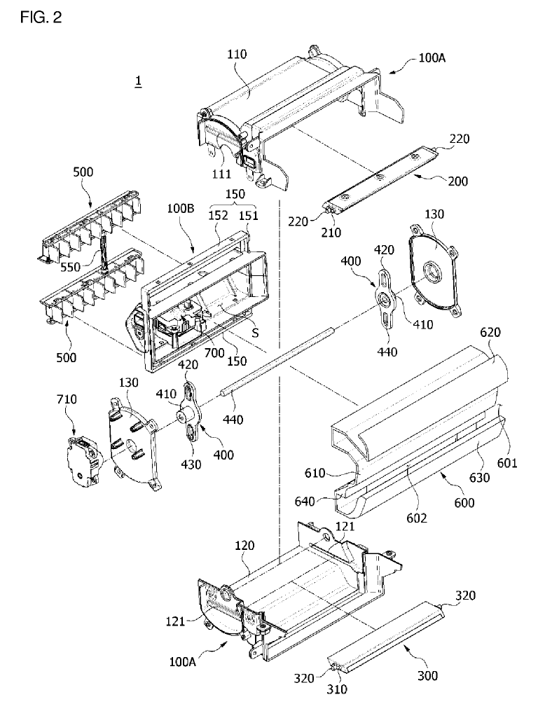

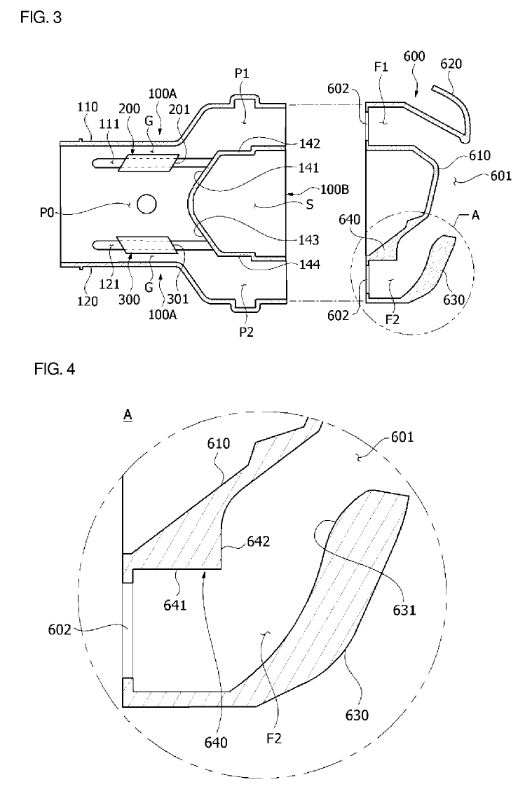

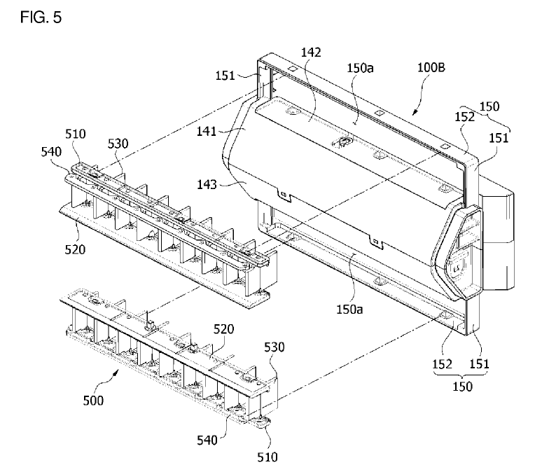

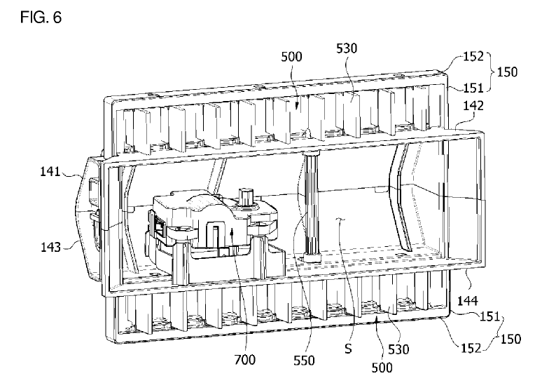

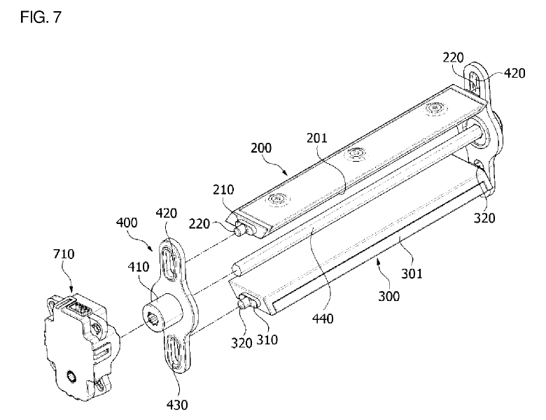

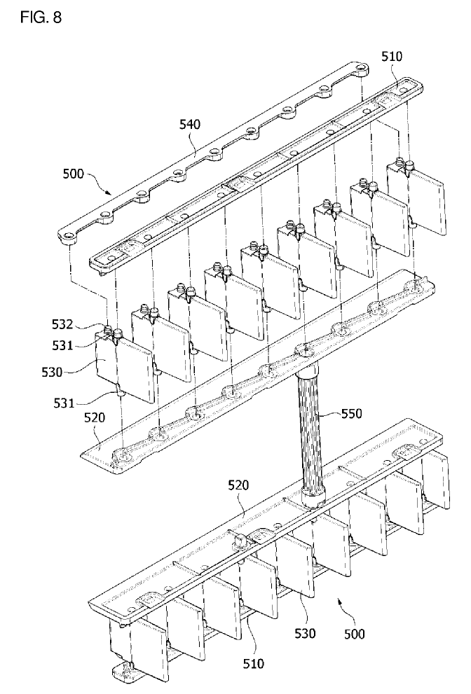

FIGS. 1 to 8 illustrate an air vent for a vehicle and its configuration according to an embodiment of the present invention.

Referring to the drawings, an air vent 1 for a vehicle according to the embodiment of the present invention may include an air duct 100, a first air guide 200, a second air guide 300, a rotator 400, and a wing module 500. In an embodiment, the air vent 1 for a vehicle may further include a guide duct 600 coupled to the air duct 100.

The air duct 100 may be connected to an air conditioning system (not illustrated) of a vehicle so that cold air and hot air generated from an air conditioning system may be supplied to a vehicle interior through the air duct 100.

The air duct 100 may have an internal flow path P0 along which air moves, a first flow path P1 branched upward from the internal flow path P0, and a second flow path P2 branched downward from the internal flow path P0. The air moving along the internal flow path P0 may move to at least one side of the first flow path P1 and the second flow path P2.

The air duct 100 may include a duct housing 100A and a duct frame 100B installed in the duct housing 100A.

The duct housing 100A may be composed of a first body 110 and a second body 120 that are separated and coupled. The internal flow path P0 may be provided inside one side of the duct housing 100A, and the first flow path P1 and the second flow path P2 may be provided inside the other side.

The duct housing 100A may have each of a pair of guide holes 111 and 121 that extend in a front-rear direction along the internal flow path P0 provided on one of both side surfaces thereof. The guide holes 111 and 121 may have a structure in the form of a straight slit. In an embodiment, the guide holes 111 and 121 may be provided in the first body 110 and the second body 120, respectively, and in a state in which the first body 110 and the second body 120 are coupled, the guide holes 111 and 121 may be disposed parallel to each other.

Side covers 130 may each be coupled to one of both sides surfaces of the duct housing 100A.

The side covers 130 are formed to cover the guide holes 111 and 121 and the rotator 400 on both side surfaces of the duct housing 100A and prevent air in the internal flow path P0 from leaking out through the guide holes 111 and 121. In this case, a rotational shaft 410 of the rotator 400 may be disposed in a structure that passes through the side cover 130 and extends to the outside.

The duct frame 100B may be disposed in front of the internal flow path P0 to form the first flow path P1 and the second flow path P2 between the duct frame 100B and the duct housing 100A.

As illustrated in the drawing, the duct frame 100B may include an upper inclined surface 141 extending to be inclined upward from a center facing the internal flow path P0, an upper plane 142 extending horizontally from an end portion of the upper inclined surface 141, a lower inclined surface 143 extending to be inclined downward from the center facing the internal flow path P0, and a lower plane 144 extending horizontally from an end portion of the lower inclined surface 143.

The upper inclined surface 141 and the upper plane 142 may form the first flow path P1 along with an inner surface of the first body 110. In addition, the lower inclined surface 143 and the lower plane 144 may form the second flow path P2 along with an inner surface of the second body 120.

A wing actuator 700 for driving the wing module 500 may be installed in an inner space S of the duct frame 100B, that is, the inner space S surrounded by the upper inclined surface 141, the upper plane 142, the lower inclined surface 143, and the lower plane 144.

In addition, a coupling hole 150a surrounded by a fixing frame 150 may be provided in each of the upper plane 142 and the lower plane 144. The fixing frame 150 may include a pair of vertical columns 151 extending from the upper plane 142 and the lower plane 144 and a horizontal column 152 connecting end portions of the pair of vertical columns 151. The fixing frame 150 may be disposed in a width direction of the duct frame 100B perpendicular to an airflow direction. The wing module 500 may be fixedly inserted into the coupling holes 150a.

The first air guide 200 and the second air guide 300 are configured to slide in the front-rear direction along the internal flow path P0 and control an air volume passing through each of the first flow path P1 and the second flow path P2.

The first air guide 200 and the second air guide 300 may be disposed in the width direction of the duct housing 100A on upper and lower portions of the internal flow path P0, respectively, and may be connected to the guide holes 111 and 121 to linearly move along the guide holes 111 and 121. For example, the first air guide 200 may be connected to the guide hole 111 within the first body 110, and the second air guide 300 may be connected to the guide hole 121 within the second body 120. In this case, a gap G for the movement of air may be provided between the first air guide 200 and the first body 110 and between the second air guide 300 and the second body 120.

The first air guide 200 and the second air guide 300 may have a flat plate-shaped structure that extends from one side surface to the other side surface of the duct housing 100A.

In an embodiment, the first air guide 200 and the second air guide 300 may have a length corresponding to a distance between both side surfaces of the duct housing 100A.

In addition, the first air guide 200 and the second air guide 300 may have a width capable of covering the first flow path P1 and the second flow path P2 in a state of moving forward along the guide holes 111 and 121 so that front surfaces 201 and 301 are in contact with the upper inclined surface 141 and the lower inclined surface 143 of the duct frame 100B, respectively. In this case, the front surface 201 of the first air guide 200 may be provided as an upward inclined surface corresponding to the upper inclined surface 141 and formed to be in close contact with the upper inclined surface 141, and the front surface 301 of the second air guide 300 may be provided as a downward inclined surface corresponding to the lower inclined surface 143 and formed to be in close contact with the lower inclined surface 143.

Depending on a degree to which the first air guide 200 and the second air guide 300 cover the first flow path P1 and the second flow path P2, respectively, the air volumes passing through the first flow path P1 and the second flow path P2 may be controlled. That is, when the first flow path P1 and the second flow path P2 are disposed to completely cover the first flow path P1 and the second flow path P2, some of the air move through the gap G and pass through the first flow path P1 and the second flow path P2, thereby reducing the air volumes. In addition, when the first flow path P1 and the second flow path P2 are disposed to be completely open, the air volumes passing through the first flow path P1 and the second flow path P2 increase maximally.

In particular, the first air guide 200 and the second air guide 300 may slide in the front-rear direction in a moving direction of air, thereby minimizing air resistance. Accordingly, it is possible to minimize the influence on the airflow within the internal flow path P0, and thus no difference occurs in the amount of distribution when distributing air to each of the first flow path P1 and the second flow path P2. In addition, air loss in which air does not completely flow into the first flow path P1 and the second flow path P2 due to the movement of air being blocked by the movement of the first air guide 200 and the second air guide 300 and thus causing an irregular flow such as eddies may not occur.

The first air guide 200 and the second air guide 300 may have guide protrusions 210 and 310, which are connected to the guide holes 111 and 121, provided on both end portions facing side surfaces of the duct housing 100A, respectively. In a state in which the guide protrusions 210 and 310 are connected to the guide holes 111 and 121, the first air guide 200 and the second air guide 300 slide along the guide holes 111 and 121.

The guide protrusion 210 of the first air guide 200 and the guide protrusion 310 of the second air guide 300 may be provided with connecting pins 220 and 320, respectively. The connecting pins 220 and 320 may be provided in a structure that protrudes outward from both side surfaces of the duct housing 100A at the centers of the guide protrusions 210 and 310.

The rotator 400 is configured to move the first air guide 200 and the second air guide 300 in different directions through rotational driving.

The rotators 400 may be rotatably installed on both side surfaces of the duct housing 100A and connected through a driving pin 440 to be rotatably driven in the same direction. In this case, the rotator 400 may be disposed outside the side surface of the duct housing 100A, and the driving pin 440 may be disposed in the duct housing 100A while crossing the internal flow path P0. The rotator 400 may be connected to the actuator 710 and rotated clockwise or counterclockwise by the operation of the actuator 710.

The rotator 400 may have a pair of connecting slots 420 and 430 extending in opposite directions centered on the central rotational shaft 410. The connecting slots 420 and 430 may have a structure of a substantially long-hole shape. The connecting pin 220 provided on the guide protrusion 210 of the first air guide 200 may be connected to an upper connecting slot 420 of the pair of connecting slots 420 and 430, and the connecting pin 320 provided on the guide protrusion 310 of the second air guide 300 may be connected to a lower connecting slot 430.

When the rotator rotates in one direction (e.g., clockwise), the upper connecting slot 420 tilts and moves forward, and the lower connecting slot 430 tilts and moves backward. In addition, the first air guide 200 connected to the upper connecting slot 420 linearly moves forward along the guide hole 111, and the second air guide 300 connected to the lower connecting slot 430 linearly moves backward along the guide hole 121.

When the rotator 400 rotates in another direction (e.g., counterclockwise), the upper connecting slot 420 tilts and moves backward, and the lower connecting slot 430 tilts and moves forward. In addition, the first air guide 200 connected to the upper connecting slot 420 linearly moves backward along the guide hole 111, and the second air guide 300 connected to the lower connecting slot 430 linearly moves forward along the guide hole 121.

The wing module 500 is installed on each of the first flow path P1 and the second flow path P2 and is formed to rotate in a left-right direction to control a discharging direction of air.

The wing module 500 may include an upper spacer 510, a lower spacer 520, a plurality of wings 530, and a wing link 540.

The upper spacer 510 and the lower spacer 520 may be disposed parallel to each other in a direction perpendicular to the moving direction of air.

A plurality of wings 530 may be disposed between the upper spacer 510 and the lower spacer 520, and each wing 530 may have a rotational shaft 531 rotatably connected to the upper spacer 510 and the lower spacer 520.

The wing link 540 may be rotatably connected to a connecting protrusion 532 of each of the plurality of wings 530. Depending on the left and right movement of the wing link 540, the plurality of wings 530 may rotate in the left or right direction.

Meanwhile, the wing module 500 installed on the first flow path P1 and the wing module 500 installed on the second flow path P2 may be connected through the connecting link 550 so that the wings 530 of each wing module 500 may be formed to rotate in the same direction. The connecting link 550 may be disposed in a structure that crosses the inner space S of the duct frame 100B and connected to the wing actuator 700 and rotatably driven.

The guide duct 600 is coupled to the front of the air duct 100 and formed to guide air moving along the first flow path P1 and the second flow path P2 to an outlet 601 that is open to the vehicle interior. In an embodiment, the guide duct 600 may be a garnish exposed to the vehicle interior.

The guide duct 600 may include a first part 610, a second upper part 620 that forms a first air passage F1 connected to the first flow path P1 between the second upper part 620 and the first part 610, and a second lower part 630 that forms a second air passage F2 connected to the second flow path P2 between the second lower part 630 and the first part 610.

In a state in which the guide duct 600 is coupled to the front of the air duct 100, the first part 610 may cover and seal the inner space S of the duct frame 100B.

The outlet 601 may be provided between the second upper part 620 and the second lower part 630 in the front of the first part 610. In addition, the first air passage F1 may be provided in a structure extending downward, and the second air passage F2 may be provided in a structure extending upward so that the first air passage F1 and the second air passage F2 may be connected at the outlet 601.

An opening 602 may be formed in each of surfaces of the first air passage F1 and the second air passage F2 of the guide duct 600, which are coupled to the air duct 100. The air moving along the first flow path P1 and the second flow path P2 may pass through the opening 602 and move along the first air passage F1 and the second air passage F2. In addition, the air may be discharged to the vehicle interior from the outlet 601.

In an embodiment, a protrusion 640 protruding from the opening 602 to the second air passage F2 may be provided on a surface of the first part 610, which faces the second lower part 630.

The protrusion 640 is composed of a horizontal portion 641 horizontally extending forward from the opening 602 and a vertical portion 642 vertically extending upward at an end of the horizontal portion 641 and formed to prevent the Coanda effect from occurring on the surface of the first part 610. That is, air moving upward from the second air passage F2 toward the outlet 601 can be prevented from flowing along the surface of the first part 610 and flowing into the first air passage F1. Meanwhile, an inner surface of the second lower part 630 facing the vertical portion 642 of the protrusion 640 is provided as a curved surface 631 to cause the Coanda effect. Accordingly, the air may flow along the curved surface 631 of the second lower part 630 and move forward from the outlet 601.

In addition, the protrusion 640 may implement a hidden structure by covering a viewing angle of the opening 602 exposed through the outlet 601. Accordingly, the opening 602 is covered by the protrusion 640 and is not exposed to the outside. In addition, since the first part 610 is exposed through the outlet 601, passengers including a driver recognizes the first upper part 620 and the second lower part 630 as a structure that is continuous by the first part 610 positioned therebetween and thus cannot intuitively recognize where the air is discharged entirely. That is, there is an effect that enables the hidden outlet 601.

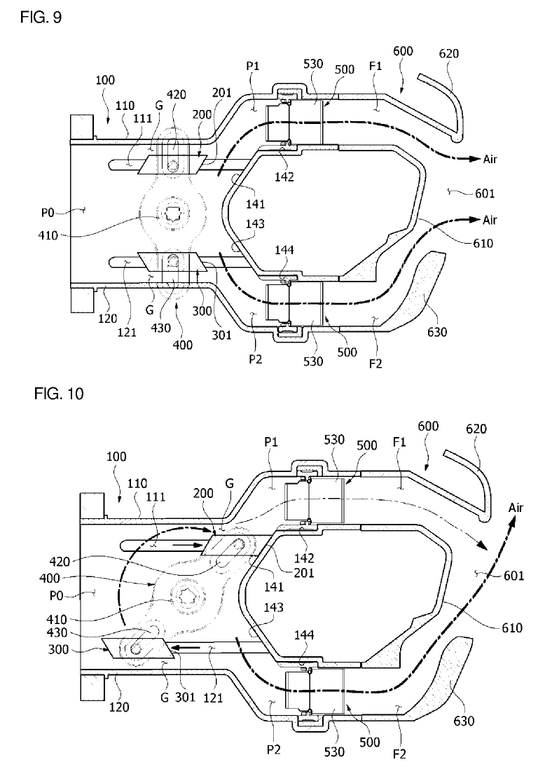

In FIGS. 9 to 11, the operation of the first air guide 200, the second air guide 300, and the rotator 400 for each mode is illustrated.

Referring to FIG. 9, in a normal mode, the rotator 400 may be rotate by the operation of the actuator 710 and positioned in a state in which the upper connecting slot 420 and the lower connecting slot 430 are vertically perpendicular. Accordingly, the first air guide 200 and the second air guide 300 may be positioned at the centers of the guide holes 111 and 121, respectively, and the first flow path P1 and the second flow path P2 may be completely open.

The air flowing into the internal flow path P0 moves along the first flow path P1 and the second flow path P2, passes through the first air passage F1 and the second air passage F2, and is discharged in a substantially horizontal direction at the outlet 601 to form a frontal wind.

Referring to FIG. 10, in an upward mode, the rotator 400 rotates clockwise by the operation of the actuator 710, and the upper connecting slot 420 tilts and moves forward, and the lower connecting slot 430 tilts and moves backward.

The first air guide 200 connected to the upper connecting slot 420 is disposed to linearly move forward along the guide hole 111 to completely cover the first flow path P1, and the second air guide 300 connected to the lower connecting slot 430 is disposed to linearly move backward along the guide hole 121 to completely open the second flow path P2.

Most of the air flowing into the internal flow path P0 moves along the second flow path P2, passes through the second air passage F2, and is discharged upward at the outlet 601 to form upward wind. In addition, some of air move along the first flow path P1 through the gap G, pass through the first air passage F1, and are merged with the upward wind at the outlet 601. In this way, it is possible to secure sufficient wind volume by not completely blocking the air from flowing into the first flow path P1 in the upward mode.

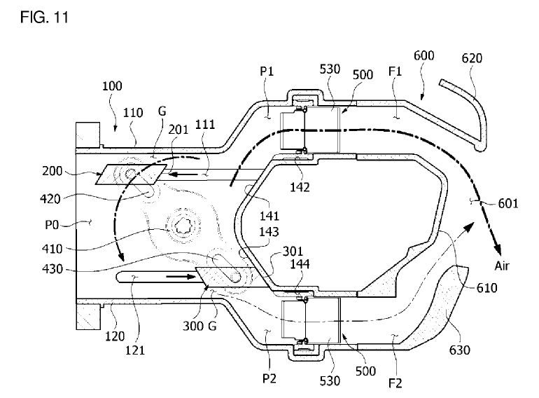

Referring to FIG. 11, in a downward mode, the rotator 400 rotates counterclockwise by the operation of the actuator 710, and the upper connecting slot 420 tilts and moves backward, and the lower connecting slot 430 tilts and moves forward.

The first air guide 200 connected to the upper connecting slot 420 is disposed to linearly move backward along the guide hole 111 to completely open the first flow path P1, and the second air guide 300 connected to the lower connecting slot 430 is disposed to linearly move forward along the guide hole 121 to completely cover the second flow path P2.

Most of the air flowing into the internal flow path P0 moves along the first flow path P1, passes through the first air passage F1, and is discharged downward at the outlet 601 to form downward wind. In addition, some of air move along the second flow path P2 through the gap G, pass through the second air passage F2, and are merged with the downward wind at the outlet 601. In this way, it is possible to secure sufficient wind volume by not completely blocking the air from flowing into the second flow path P2 in the downward mode.

Further, one or more controllers/processors (not shown) may control the first air guide 200 and the second guide 300 to slide in a front-rear direction, and respectively control air volume passing through the first flow path 200 and the second flow path 300, control the rotator 400 to rotate the first air guide 200 and the second air guide 300 in different directions, and/or control the wing actuator 700 to control the wing module 500 to rotate in a left-right direction and control a discharging direction of air.

As described above, the air vent for a vehicle according to the embodiment of the present invention has the effect of not causing wind volume loss by omitting the existing wing for controlling the vertical wind direction and the wing knob provided on the wing.

In addition, the wing and the wing knob are omitted to enable slimming.

In addition, since the guide duct having the outlet for discharging air is exposed to the vehicle interior and serves as a garnish, there is no need for a separate garnish, and thus it is possible to reduce costs, and since the opening through which the air is discharged is provided as a hidden structure to be covered and invisible, aesthetics are improved.

According to the present invention, it is possible to provide the air vent for a vehicle, which enables the hidden outlet without causing wind volume loss because the wing for controlling the vertical wind direction and the wing knob provided on the wing are omitted.

Effects of the present invention are not limited to the above-described effects, and other effects that are not mentioned will be able to be clearly understood by those skilled in the art from the following description.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An air vent for a vehicle, the air vent comprising:
an air duct including:
an internal flow path along which air is configured to flow;
a first flow path branched upward from the internal flow path; and
a second flow path branched downward from the internal flow path;
a first air guide and a second air guide respectively disposed on upper and lower portions of the internal flow path, the first air guide and the second guide configured to:
slide in a front-rear direction; and
respectively control an air volume passing through the first flow path and the second flow path;
a rotator rotatably installed on one side surface of the air duct and configured to move the first air guide and the second air guide in different directions through rotation driving; and
a wing module installed on each of the first flow path and the second flow path, the wing module configured to:
rotate in a left-right direction; and
control a discharging direction of the air.

2. The air vent of claim 1, wherein the air duct includes a duct housing and a duct frame installed in the duct housing,
wherein the duct housing includes a pair of guide holes on both side surfaces extending in the front-rear direction along the internal flow path, and
wherein the duct frame is disposed in front of the internal flow path and configured to form the first flow path and the second flow path between the duct frame and the duct housing.

3. The air vent of claim 2, wherein the duct frame includes:
an upper inclined surface extending to be inclined upward at a center facing the internal flow path;
an upper plane horizontally extending from an end portion of the upper inclined surface;
a lower inclined surface extending to be inclined downward at a center facing the internal flow path;
a lower plane horizontally extending from an end portion of the lower inclined surface; and
a wing actuator for driving the wing module, the wing actuator being installed in an inner space surrounded by the upper inclined surface, the upper plane, the lower inclined surface, and the lower plane.

4. The air vent of claim 3, wherein a coupling hole surrounded by a fixing frame including a pair of vertical columns and a horizontal column connecting the pair of vehicle columns is provided in the upper plane and the lower plane, and
wherein the wing module is configured to be fixedly inserted into the coupling hole.

5. The air vent of claim 2, wherein side covers covering the guide hole and the rotator are coupled to both side surfaces of the duct housing, and
wherein the side cover is configured to prevent air in the internal flow path from leaking out through the guide hole.

6. The air vent of claim 2, wherein the first air guide and the second air guide have a plate-shaped structure extending toward both side surfaces of the duct housing, and
wherein the first air guide and the second air guide each have a guide protrusion, which is connected to the guide hole, provided in both end portions facing the side surfaces.

7. The air vent of claim 6, wherein the rotator includes:
a pair of connecting slots extending in opposite directions centered on a central rotational shaft; and
a connecting pin provided on the guide protrusion of the first air guide, the guide protrusion of the second air guide being connected to each of the pair of connecting slots.

8. The air vent of claim 1, wherein the wing module includes:
an upper spacer and a lower spacer disposed parallel to each other;
a plurality of wings having a rotational shaft rotatably connected to the upper spacer and the lower spacer;
a wing link rotatably connected to each of the plurality of wings, and
wherein the wing module installed on the first flow path and the wing module installed on the second flow path are connected through a connecting link and formed to rotate in the same direction.

9. The air vent of claim 1, further comprising:
a guide duct coupled to a front of the air duct to guide air moving along the first flow path and the second flow path to an outlet that is open to a vehicle interior, the guide duct including:
a first part;
a second upper part forming a first air passage connected to the first flow path between the second upper part and the first part; and
a second lower part forming a second air passage connected to the second flow path; and
an opening formed in each of the surfaces of the first air passage and the second air passage of the guide duct that are coupled to the air duct.

10. An air vent for a vehicle, the air vent comprising:
an air duct including:
an internal flow path along which air is configured to flow;
a first flow path branched upward from the internal flow path; and
a second flow path branched downward from the internal flow path;
a first air guide and a second air guide respectively disposed on upper and lower portions of the internal flow path;
a rotator rotatably installed on one side surface of the air duct;
a first wing module installed on the first flow path and a second wing module installed on the second flow path;
a wing actuator connected to the first and the second wing modules, and configured to adjust the direction of air flow through the first and the second wing modules;
a controller configured to:
control the first air guide and the second guide to slide in a front-rear direction, and respectively control air volume passing through the first flow path and the second flow path;
control the rotator to rotate the first air guide and the second air guide in different directions;
control the wing actuator to control the wing module to rotate in a left-right direction and control a discharging direction of air.

11. The air vent of claim 10, wherein the air duct includes a duct housing and a duct frame installed in the duct housing,
wherein the duct housing includes a pair of guide holes on both side surfaces extending in the front-rear direction along the internal flow path, and
wherein the duct frame is disposed in front of the internal flow path and configured to form the first flow path and the second flow path between the duct frame and the duct housing.

12. The air vent of claim 10, wherein the wing module includes:
an upper spacer and a lower spacer disposed parallel to each other;
a plurality of wings having a rotational shaft rotatably connected to the upper spacer and the lower spacer;
a wing link rotatably connected to each of the plurality of wings, and
wherein the wing module installed on the first flow path and the wing module installed on the second flow path are connected through a connecting link and formed to rotate in the same direction.

13. The air vent of claim 10, further comprising:
a guide duct coupled to a front of the air duct to guide air moving along the first flow path and the second flow path to an outlet that is open to a vehicle interior, the guide duct including:
a first part;
a second upper part forming a first air passage connected to the first flow path between the second upper part and the first part; and
a second lower part forming a second air passage connected to the second flow path; and
an opening formed in each of the surfaces of the first air passage and the second air passage of the guide duct that are coupled to the air duct.
